(19) United States
(12) Patent Application Publication
(10) Pub. No.: US 2010/0115843 A1
(43) Pub. Date: May 13, 2010

(54) GATE FOR PERSONS

(76) Inventor: Thomas Gallenschuetz, Buehl (DE)

Correspondence Address: COLLARD & ROE, P.C., 1077 NORTHERN BOULEVARD, ROSLYN, NY, 11576, US

(21) Appl. No.: 12/452,105

(22) PCT Filed: Jun. 11, 2008
(86) PCT No.: PCT/EP2008/057299

§ 371 Date: Dec. 30, 2009

(30) Foreign Application Priority Data
Jun. 15, 2007 (DE) 10 2007 028 269.0

(51) Int. Cl. E06B 11/02

(52) U.S. Cl. 49/49

(57) ABSTRACT

The invention relates to a gate for persons for cyclically opening a passage having at least one blocking element connected to a moveable carrier element and moveable from a blocking position blocking passage at a blocking site into a passage position allowing passage, having a blocking device for blocking the movement of the carrier element comprising at least one bar (18, 20) contacting a working surface (16) of the carrier element at least one contact point in a blockage position, the bar (18, 20) being moveable from the blockage position into an open position, the movement thereof at the contact point taking place in a first direction of motion, and the working surface (16) moving in a second direction of motion at the contact point when the carrier element moves. According to the invention, an angle β between the first direction of motion and a tangent at the line of intersection of the tangential surface with the working surface (16) at the contact point is included in the plane passing through the first and the second directions of motion, the tangent thereof (tan β) being described by 5/9μ≦tan β≦9/5μ, μ being the coefficient of static friction between the bar (18, 20) and the working surface (16).

The invention relates to a security gate in accordance with the preamble of claim 1.

Security gates of the type stated initially, such as revolving doors and turnstiles, serve to block off a passage and, if necessary, to release it for a defined number of persons, for a short period of time, for example if access entitlement has been demonstrated. For this purpose, the security gate has at least one blocking element, preferably multiple blocking elements, which are configured as blocking crosspieces in the case of a turnstile and as door panels in the case of a revolving door. These are movable on a closed track, for release and subsequent blocking of the passage. In order to allow blocking of the passage, the blocking elements are connected with a carrier element that is configured, for example, as a blocking disk that can be rotated about an axis of rotation. Blocking cams project radially from the blocking disk, which cams have lateral functional surfaces. The security gate furthermore has a blocking device that has one or more locking bars that can be moved from a release position into a blockade position. In the blockade position, at least one of the locking bars lies against a functional surface and inhibits movement of the blocking disk, and thus movement of the blocking elements.

For safety reasons, it must be guaranteed in many areas of application that in the event of an emergency, passage through the security gate is released. For this reason, in the case of known security gates, the locking bars are held in the release position by means of a spring force, and are moved into the blockade position, for blocking, by motors, for example by means of lifting magnets. If the power fails, for example, the power of the lifting magnets fails and the reset force attempts to move the locking bars into the release position, so that the passage is released. If, however, a person presses against a blocking element when a locking bar is in the blockade position, the functional surface of the cam is question is pressed against the locking bar and a great amount of spring force is required to move the locking bar into the release position. The same problem also occurs if a person is already pressing against a blocking element before release takes place. It is true that making a great reset force available does not represent any great design difficulties. However, it requires a very strong lifting magnet for moving the locking bar into the blockade position, which makes the security gate significantly more expensive and furthermore makes it large in construction, causes noise during closing, and develops heat during operation.

It is therefore the task of the invention to further develop a security gate of the type stated initially, in such a manner that the locking bar or bars can be moved into the release position even with a lesser reset force.

This task is accomplished, according to the invention, by means of a security gate having the characteristics of claim 1. Advantageous further developments of the invention are the object of the dependent claims.

The invention is based on the idea that in the case of a corresponding geometry of the cam, not only does a static friction force that inhibits movement of the locking bar occur when the cam is pressed against the locking bar, but rather, a force that corresponds to the downgrade force on a slanted plane, which supports movement of the locking bar, also occurs. This force is merely dependent on the geometry of the placement of the locking bar relative to the functional surface, while the static friction force is dependent on the static friction force coefficient μ, which in turn is predetermined by the materials of the locking bar and of the cam. Just as an incline angle α=arctan μ exists in the case of the slanted plane, at which angle static friction force and downgrade force mutually cancel one another out, and an infinitesimal force triggers slipping of the object that lies on the slanted plane, an angle also exists in the present case, at which the static friction force and the force that promotes movement of the locking bar and corresponds to the downgrade force, are in balance with one another. Release of the passage can then take place with a relatively weak reset force on the locking bar, which shifts the force equilibrium to such an extent that the force that supports movement of the locking bar is greater than the static friction force. The less the angle β defined in claim 1 deviates from α=arctan μ, the weaker the reset spring can be configured to be, and the weaker the lifting magnet that moves the locking bar into the blockade position can be configured to be, and this results in cost savings. In this connection, it is preferred that the angle β is slightly smaller than the angle α=arctan μ, so that the static friction force is still slightly greater than the force that promotes movement of the locking bar and corresponds to the downgrade force. However, it is also possible that the angle p is slightly greater than the angle α=arctan μ. In order to achieve reliable blocking of the passage, however, the force for holding the cam in the blockade position, which is applied by a motor, must slightly exceed the reset force, in order to achieve reliable blocking of the passage during operation. The idea of the invention is fundamentally implemented if the static friction force is maximally 80% greater than the force that corresponds to the downgrade force (tan β≦9/5μ) and vice versa (5/9μ≧tan β). Smaller deviations, such as maximally 40%, maximally 30%, maximally 20%, or maximally 10%, for example, are advantageous.

Fundamentally, the carrier element can be provided with one or more slits into which the locking bar engages in its blockade position, and lies against the functional surface that delimits the slit in question. However, it is preferred that the carrier element has a base body and at least one cam that projects away from the base body, whereby the functional surface is disposed laterally on the cam.

Fundamentally, both a linear movement of the carrier element and of the cam that projects away from its base body, and a linear movement of the locking bar between the blockade position and the release position are possible. However, it is preferred that the at least one locking bar can be pivoted about a pivot axis between the release position and the blockade position. Likewise, it is preferred that the carrier element is a disk that can rotate about an axis of rotation, from which the at least one cam projects radially. The first movement direction then runs tangential to a circle, about a point on the pivot axis, through the contact point; the second movement direction runs tangential to a circle about the axis of rotation of the disk through the contact point.

Fundamentally, it is sufficient if the locking bar lies against the cam merely at one contact point. However, it is preferred that the locking bar lies against the cam at multiple contact points in its blockade position, and preferably over its full area. In this case, it is preferred that at every contact point, it holds true for the angle β between the first movement direction and the tangent at the intersection line of the tangential surface on the functional surface at the contact point in question with the plane that passes through the first and the second movement direction that 5/9μ≦tan β≦9/5μ. Alternatively, this can also apply on average for the contact points, whereby in the case of full-area contact, the average is formed by the quotient of the surface integral and the surface. Full-area contact of the locking bar against the functional surface of the cam avoids a load only at certain points, and makes lesser demands on the surface quality or hardness, because of the lower surface pressure.

It is advantageous if the functional surface is a planar surface. A cylindrical mantle surface is also possible. This can be produced in particularly simple manner. However, it is also possible that the intersection line of the functional surface with the plane that passes through the first and the second movement direction is a section of a logarithmic spiral with its origin on the pivot axis. It is true that this embodiment variant is more difficult to produce, but it allows implementation of the principle according to the invention (cancellation of the static friction force by means of a force that corresponds to the downgrade force, to a great extent) at every contact point.

In the following, the invention will be explained in greater detail using an exemplary embodiment shown schematically in the drawing. This shows

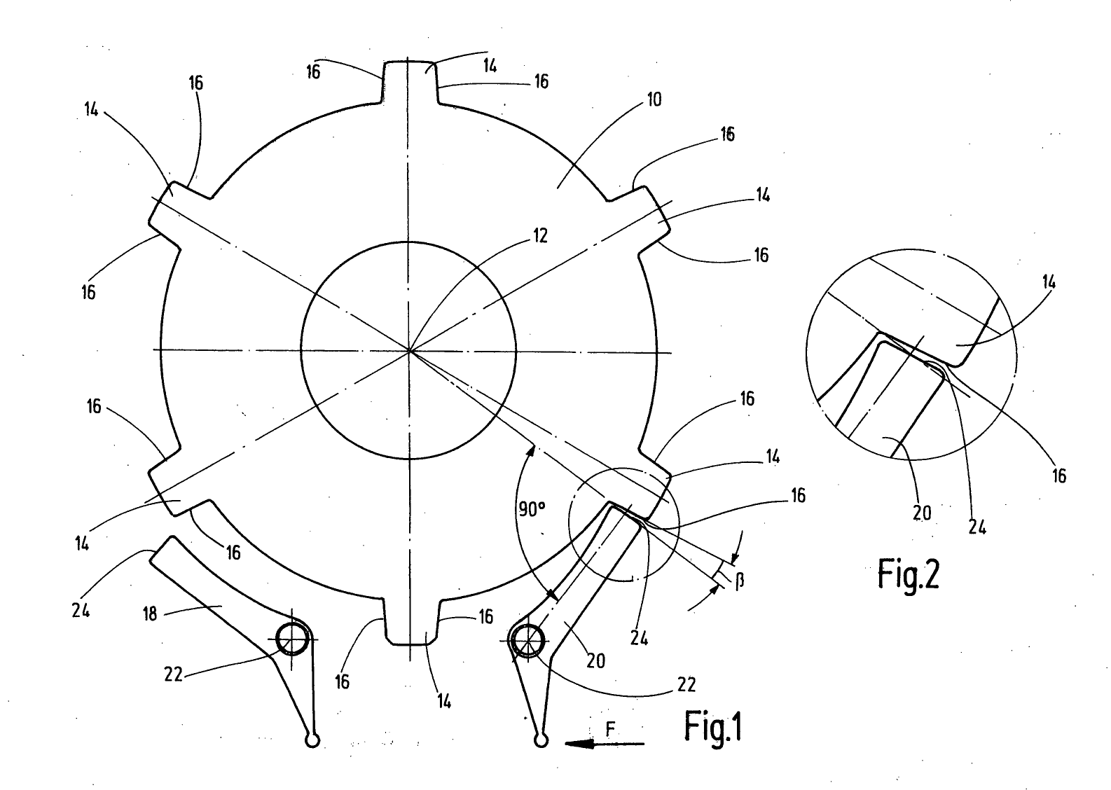

FIG. 1 a top view of a carrier element configured as a blocking disk, with a blocking device, in a schematic representation, and

FIG. 2 a detail from FIG. 1.

In the drawing, a locking mechanism for a turnstile is shown. This mechanism has a blocking disk 10 that can be rotated about an axis of rotation 12. The blocking disk 10 is firmly connected with the blocking crosspieces of the turnstile, so that the blocking crosspiece that projects into a passage of the security gate cannot be moved if the rotational movement of the disk is blocked, and thus blocks the passage. On the circumference of the blocking disk 10, which is essentially circular in a top view, cams 14 disposed at constant angle intervals project away in the radial direction and have lateral functional surfaces 16. In order to be able to block the rotational movement of the blocking disk 10, two locking bars 18, 20 are mounted close to the blocking disk 10, so as to pivot about pivot axes 22. By means of being pivoted about the pivot axes 22, the locking bars 18, 20 can be pivoted between a release position and a blockade position. In the exemplary embodiment shown in FIG. 1, the left locking bar 18, with which the rotational movement of the blocking disk 10 in the counterclockwise direction can be blocked, is in the release position. The blocking disk 10 can therefore be rotated about the axis of rotation 12 in the counterclockwise direction. The right locking bar 20, in contrast, is in the blockade position. In this connection, a contact surface 24 lies against one of the functional surfaces 16 and inhibits rotation of the blocking disk 10. Pivoting of the locking bars 18, 20 between the release position and the blockade position takes place by means of a spring that brings about a reset force F, which permanently acts on the locking bar 18, 20, in each instance, and presses the locking bar 18, 20 into the release position in the absence of any other forces. In order to move the locking bars 18, 20 into the blockade position, lifting magnets are provided, which counteract the reset force F when activated.

If the locking bar 20 is to be moved from the blockade position shown in the drawing into the release position, then the reset force F counteracts the static friction force that is in effect between the contact surface 24 of the locking bar 20 and the functional surface 16 of the cam 14. This force is all the greater, the more a person presses against the blocking crosspiece that blocks the passage, whereby this force is transferred from the blocking crosspiece to the cam 14 and causes the functional surface 16 to be pressed against the contact surface 24. In order to improve mobility of the locking bar 20 in such a situation, the movement direction of the locking bar 20 encloses an angle β with the movement direction of the functional surface 16 at every contact point, such that the static friction force is cancelled out by a force that is directed outward and corresponds to the downgrade force. To state it more generally, the angle β, in each instance, is situated between the movement direction of the locking bar 20 at the contact point in question and the intersection of the tangential surface at the functional surface 16 at the contact point with the plane of rotation, in each instance (drawing plane in FIG. 1), whereby in the present exemplary embodiment, in which the functional surface 16 is configured as a planar surface, the tangential surface at the functional surface 16 corresponds to the functional surface itself 16. By means of this measure, a force that corresponds to the downgrade force occurs when the functional surface 16 is pressed against the contact surface 24, which force facilitates movement of the locking bar 18, 20. In the present case, this force, which corresponds to the downgrade force, is only slightly less than the static friction force, and it holds true for every angle β that μcos β<1.05·sin β, so that the static friction force exceeds the force that corresponds to the downgrade force by less than 5%. In this connection, μ is the static friction coefficient between the functional surface 16 and the contact surface 24, which is dependent on the materials selected. If both the locking bars 18, 20 and the blocking disk 10 are made from steel, then μ amounts to approximately 0.15.

In summary, the following should be stated:

The invention relates to a security gate for cyclical release of a passage, having at least one blocking element that is connected with a movable carrier element and can be moved from a blocking position in which passage is blocked at a blocking location, to a passage position in which the passage is released, by means of moving the carrier element, with a blocking device for blocking the movement of the carrier element that has at least one locking bar 18, 20, which, in a blockade position, lies against a functional surface 16 of the carrier element at at least one contact point, whereby the locking bar 18, 20 can be moved from the blockade position into a release position, whereby its movement at the contact point takes place in a first movement direction, and whereby the functional surface 16 moves in a second movement direction at the contact point, if the carrier element is moved. According to the invention, it is provided that an angle β is enclosed at the contact point, between the first movement direction and a tangent on the intersection line of the tangential surface on the functional surface 16 at the contact point with the plane that passes through the first and the second movement direction, for the tangent of which (tan β) 5/9μ≦tan β≦9/5μ applies, whereby p is the static friction coefficient between the locking bar 18, 20 and the functional surface 16.

1. Security gate for cyclical release of a passage, having at least one blocking element that is connected with a movable carrier element and can be moved from a blocking position in which the passage is blocked at a blocking location, to a passage position in which the passage is released, by means of moving the carrier element, with a blocking device for blocking the movement of the carrier element that has at least one locking bar (18, 20), which, in a blockade position, lies against a functional surface (16) of the carrier element at at least one contact point, whereby the locking bar 18, 20 can be moved from the blockade position into a release position, whereby its movement at the contact point takes place in a first movement direction, whereby this movement counteracts a static friction force that is in effect between the locking bar (18, 20) and the functional surface (16), and whereby the functional surface (16) moves in a second movement direction at the contact point, if the carrier element is moved, wherein an angle 13 is enclosed at the contact point, between the first movement direction and a tangent on the intersection line of the tangential surface on the functional surface (16) at the contact point with the plane that passes through the first and the second movement direction, for the tangent of which (tan β) 5/9μ≦tan β≦9/5μ applies, whereby μ is the static friction coefficient between the locking bar (18, 20) and the functional surface (16).

2. Security gate according to claim 1, wherein the carrier element has a base body (10), and at least one cam (14) that projects away from the base body (10), whereby the functional surface (16) is disposed laterally on the cam (14).

3. Security gate according to claim 1, wherein the at least one locking bar (18, 20) can be pivoted about a pivot axis (22), between the release position and the blockade position.

4. Security gate according to claim 2, wherein the carrier element has a disk (10) that can be rotated about an axis of rotation (12), from which the at least one cam (14) projects radially.

5. Security gate according to claim 1, wherein the at least one locking bar (18, 20), in its blockade position, lies against the at least one functional surface (16) at multiple contact points, and preferably in planar manner, and wherein at every contact point, it holds true for the angle β between the first movement direction and the tangent on the intersection line of the tangential surface on the functional surface (16) at the contact point, in each instance, with the plane that passes through the first and the second movement direction, that 5/9μ≦tan β≦9/5μ applies.

6. Security gate according to one claim 1, wherein the at least one locking bar (18, 20), in its blockade position, lies against the at least one functional surface (16) at multiple contact points, and preferably in planar manner, and wherein on the average over the functional surface, 5/9μ≦tan β≦9/5μ applies, whereby β is the angle between the first movement direction and the tangent on the intersection line of the tangential surface on the functional surface (16) at the contact point, in each instance, with the plane that passes through the first and the second movement direction.

7. Security gate according to claim 1, wherein the functional surface (16) is a planar surface.

8. Security gate according to claim 3, wherein the intersection line of the functional surface (16) with the plane that passes through the first and the second movement direction is a logarithmic spiral with its origin on the pivot axis (22).
